(19) United States
(12) Patent Application Publication
(10) Pub. No.: US 2026/0087384 A1
(43) Pub. Date: Mar. 26, 2026

(54) PERSONAL ARTIFICIAL INTELLIGENCE AGENT CREATION AND PERFORMANCE OF ACTIONS ON A COMPUTING DEVICE

(71) Applicant: Simular, Inc., Palo Alto, CA (US)

(72) Inventors: Jiachen Yang, Redwood City, CA (US); Chih-Lun Lee, Sunnyvale, CA (US); Hao Liu, Palo Alto, CA (US); Ang Li, San Carlos, CA (US)

(21) Appl. No.: 19/339,137

(22) Filed: Sep. 24, 2025

Related U.S. Application Data
(60) Provisional application No. 63/698,392, filed on Sep. 24, 2024.

(51) Int. Cl. G06N 5/04; G06F 16/953

(52) U.S. Cl. CPC G06N 5/04; G06F 16/953

(57) ABSTRACT

Methods, systems, and apparatus, including computer programs encoded on computer storage media for performance of actions on a computing device using a personal artificial intelligence agent. The system receives, via a user interface of a client device, an input related to the execution of a computer-related task, the input comprising a text or an audio signal converted to text. The system determines one or more services, databases or APIs to retrieve data or information related to the received input and asynchronously obtains the data or information. The system determines one or more actions to be performed responsive to received input. The system provides a generated prompt as input to one or more machine learning models comprising a large language model, the received input and/or the determined or more actions. The system performs the determined one or more actions by the client device.

### CROSS-REFERENCE TO RELATED APPLICATIONS

This application is a non-provisional application and claims priority to U.S. Application No. 63/698,392 filed on Sep. 24, 2024.

### FIELD

This application relates generally to automating computer processing, and more particularly to systems and methods for performance of actions on a computing device using a personal artificial intelligence agent.

### SUMMARY

The system provides a personal AI assistant adapted to empower users by automating everyday computer tasks on a computing device. The personal AI assistant understands natural language commands and allows users to interact with the personal AI assistant in a conversational way. The personal AI assistant processes received input that instructs the personal AI assistant to perform computer tasks on the computing device. The personal AI assistant uses one or more generative AI systems using large language models (LLMs) to create tasks to be performed by the computing device.

Methods, systems, and apparatus, including computer programs encoded on computer storage media for performance of actions on a computing device using a personal artificial intelligence agent. The system receives, via a user interface of a client device, an input related to the execution of a computer-related task, the input comprising text or an audio signal converted to text. The system determines one or more services, databases or APIs to retrieve data or information related to the received input and asynchronously obtains the data or information. The system determines one or more actions to be performed responsive to received input. The system provides a generated prompt as input to one or more machine learning models comprising a large language model, the received input and/or the determined or more actions. The system performs the determined one or more actions by the client device.

The appended claims may serve as a summary of this application.

### BRIEF DESCRIPTION OF THE DRAWINGS

FIG. 1A-1B are diagrams illustrating aspects of the system according to some embodiments.

FIG. 2 is a diagram illustrating aspects of the system according to some embodiments.

FIG. 3 is a diagram illustrating aspects of the system according to some embodiments.

FIG. 4 is a diagram illustrating aspects of the system according to some embodiments.

FIG. 5 is a diagram illustrating aspects of the system according to some embodiments.

FIG. 6 is a diagram illustrating aspects of the system according to some embodiments.

FIG. 7 is a diagram illustrating aspects of the system according to some embodiments.

FIG. 8 is a diagram illustrating aspects of the system according to some embodiments.

FIG. 9 is a diagram illustrating a process of the system that may be performed in some embodiments.

FIG. 10 is a diagram illustrating a process of the system that may be performed in some embodiments.

FIG. 11 is a flow chart illustrating an exemplary method that may be performed in some embodiments.

FIG. 12 is a flow chart illustrating an exemplary method that may be performed in some embodiments.

FIG. 13 is a diagram illustrating and example process using an artificial agent to perform a user query according to some embodiments.

FIGS. 14A-14B are a diagram of FIG. 13 depicted on two separate sheets.

FIGS. 15A-15C are diagrams illustrating an exemplary user interface according to some embodiments.

FIG. 16 is a diagram illustrating training and continuous learning model.

FIG. 17 is a diagram illustrating processing of an existing set of tasks via the trained one or more machine learning models.

FIG. 18 is a diagram illustrating continued processing from FIG. 17.

FIG. 19 is a diagram illustrating an architecture of the system in some embodiments.

FIG. 20 is a diagram illustrating an exemplary computer that may perform processing in some embodiments.

### DETAILED DESCRIPTION OF THE DRAWINGS

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and their equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

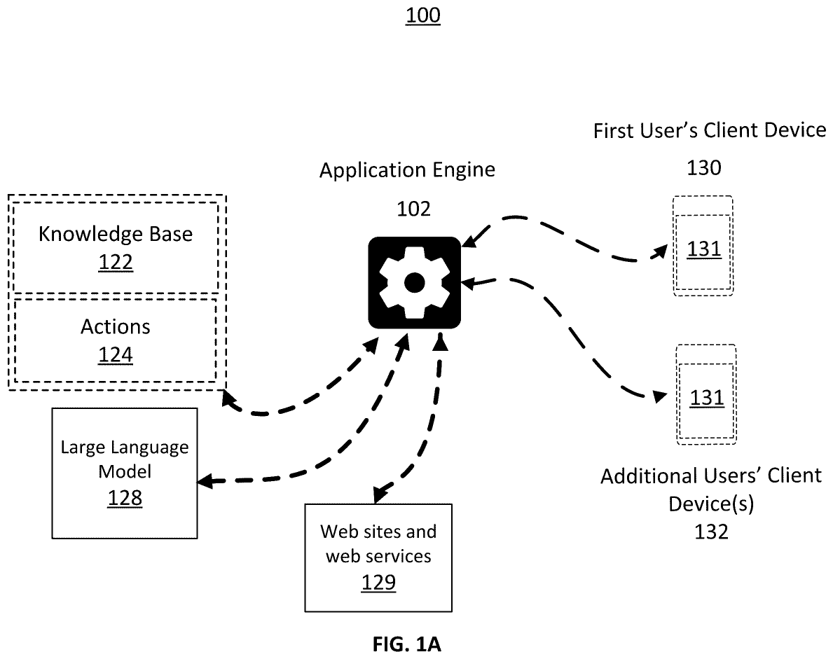

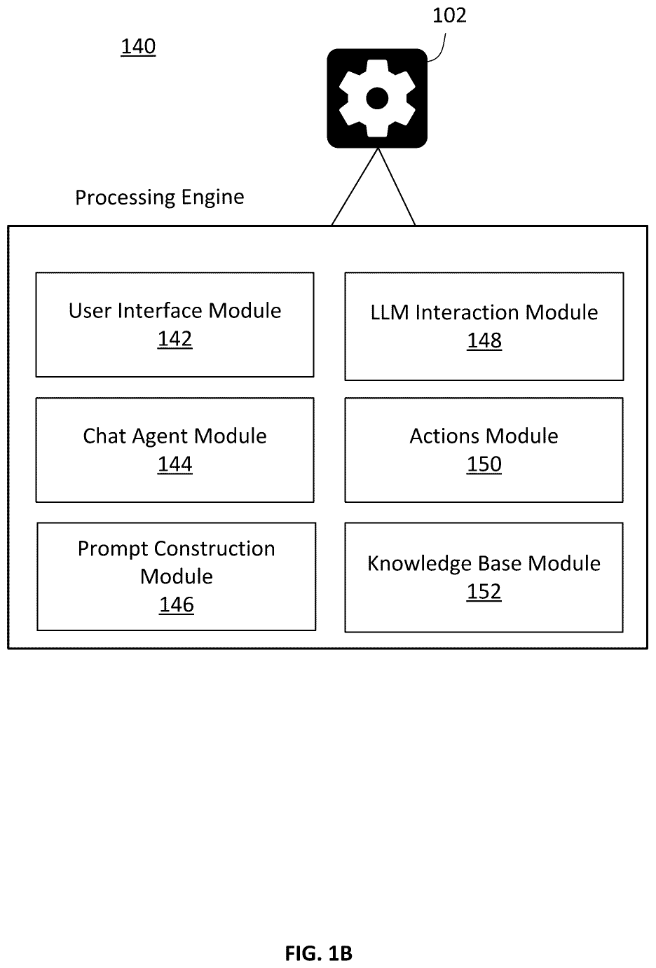

FIG. 1A is a diagram illustrating an exemplary environment in which some embodiments may operate. In the exemplary environment 100, a first user's client device 130 and one or more additional users' client device(s) 132 are connected to an application engine 102. The client devices 130, 132 may interact with one or more websites (e.g., web services) running a code or a service for interaction with the application engine 102. The application engine 102 may include one or more modules performed on a respective client device 130, 132, on one or more servers, or a combination thereof.

The application engine 102 generates user interfaces allowing a user of a client device to interact with a chat agent 131. The application engine is connected to one or more machine learning networks (e.g., large language models and generative AI model-based system). The application engine 102 is connected to one or more repositories (e.g., non-transitory data storage) and/or databases, including a knowledge database 122 and an actions database 124. One or more of the databases may be combined or split into multiple databases. In some embodiments, the application engine 102 may perform the methods as described herein, as a result, provide interactive user interfaces used to receive user input and display results to a user of a client device 130, 132. The application engine 102 interacts and communicates with one or more generative AI systems having a large language model and with one or more Internet-based web sites and web services 192.

The first user's client device 130 and additional users' client device(s) 132 in this environment may be computers, mobile devices, which are communicatively coupled to one or more servers operating the application engine. The application engine 102 may operate on a mobile device or partly on a mobile device 130, 132 and partly on a server or other computers.

In some embodiments, the first user's client device 130 and additional users' client device(s) 132 are computing devices capable of hosting and executing one or more applications or other programs capable of sending and/or receiving information. In some embodiments, the first user's client device 130 and/or additional users' client device(s) 132 may be a computer desktop or laptop, mobile phone, any other suitable computing device.

FIG. 1B is a diagram illustrating an exemplary computer system with software and/or hardware modules that may execute some of the functionality described herein. Computer system 150 may comprise, for example, a server or client device or a combination of server and client devices for automated configuration of software systems using images of hardware components or peripherals. The exemplary computer system 140 is shown with the application engine 102 performing multiple modules. For example, in some embodiments, the modules include a user interface module 142, chat agent module 144, a prompt construction module 146, an large language model (LLM) interaction module, an actions module 150, and a knowledgebase search/retrieval module 152.

The User Interface Module 142 provides system functionality for presenting a user interface to the client devices 130, 132.

The Chat Agent Module 144 provides system functionality for interacting with a user of a client device and receiving and processing input for the performance of tasks.

The Prompt Construction Module 146 provides system functionality for the generation and formation of prompts to be used as input to an LLM or generative AI model based system.

The LLM Interaction Module 148 provides system functionality for the interaction with one or more LLMs based on prompts generated by the system 100.

The Actions Module 150 provides system functionality to generate tasks to be performed by a client device 130, 132.

The Knowledge Base Module 152 provides system functionality to store, search and retrieve information to a knowledge base associated with a user and/or a client device.

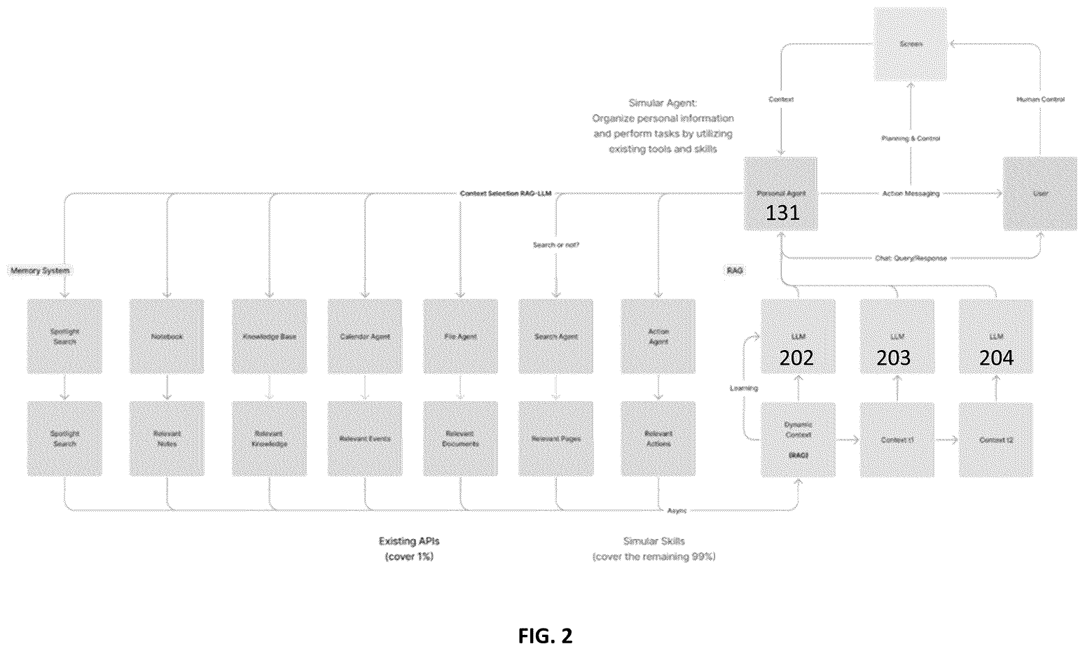

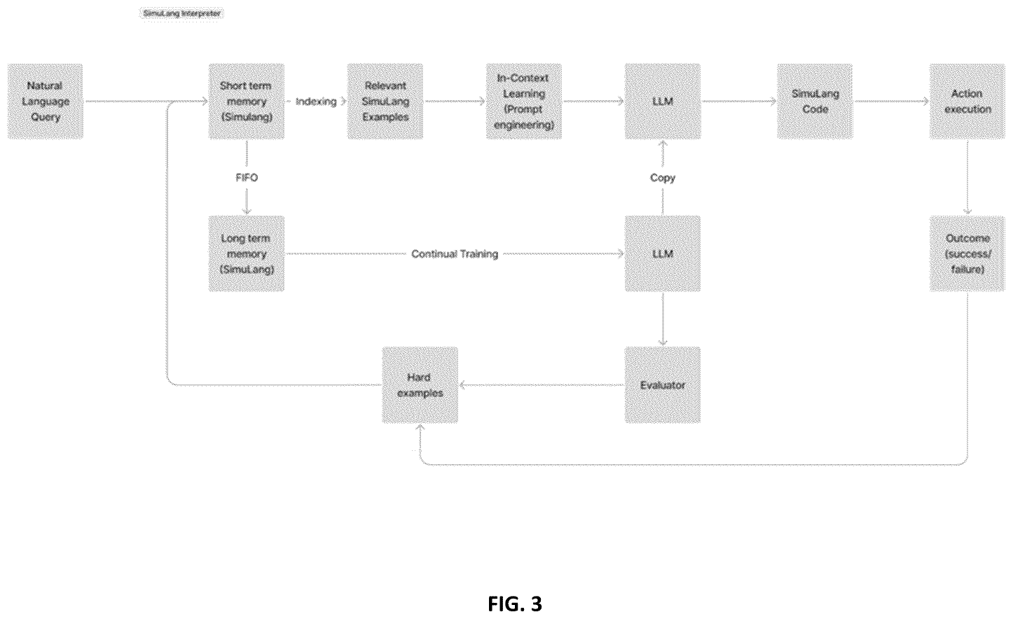

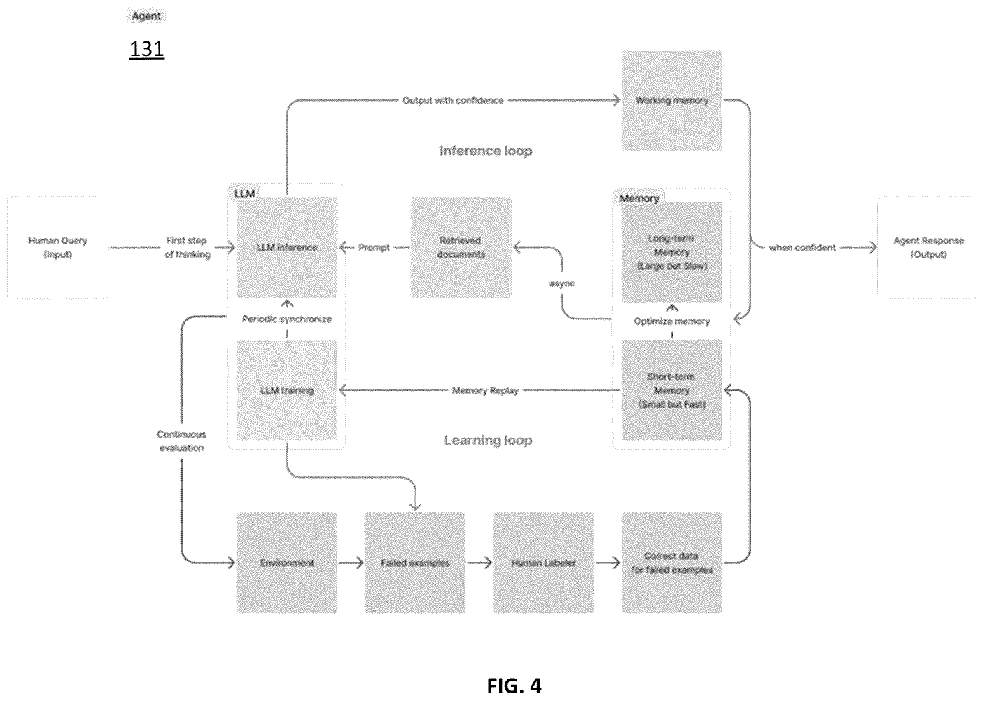

Referring to FIGS. 2-4, the diagram illustrates aspects of the system according to some embodiments. In this FIG. 2, the system illustrates the personal agent 131 performing context selection RAG processing via different application programming interfaces, application and software (e.g., a spotlight search (or file manager search), notebook, knowledge base, calendar, file, search.) Also, the artificial intelligence agent is depicted as interaction with an action agent to identify relevant action and/or commands to perform the actions. One or more LLMs 202, 203, 204 may be used by the personal agent 131 to determine task to be performed by the agent.

In some embodiments, the system performs the operations of:
receiving, via a user interface of a computing device, a textual or audio signal converted to text;
determining, by the system, one or more services, databases or APIs to retrieve data or information related to the user input, and receiving asynchronously the data or information;
determining one or more actions to be performed by the system related to the user input;
providing as input as a prompt to one or more machine learning models comprising a large language model, the received input and/or the determined or more actions
performing the one or more determined actions by the system, wherein the one or more actions comprises selection of one or more applications or computer services on the computing device.

In some embodiments, the system performs the operations of:
receiving, via a user interface of a computing device, user input interaction, wherein the user input interactions comprise one or more of keyboard inputs, mouse inputs, touch inputs, touch pad inputs; and
generating and storing an action based on the received user input interactions with the computing device.

In some embodiments, the system performs Retrieval Augmented Generation processes to organize information and decide on which context to use a user query received as input via a user interface of a client device. For example, when the user interface receives an input from a suer for a question, the personal agent decides what context to use in responding the query.

In some embodiments, the system uses a multiple faceted RAG approach. For example, the system may use a first RAG sub-system where the data is stored as key-value pairs (e.g, a key represents the query and a value represents the set of data used.) This first RAG sub-system is used in obtaining the corresponding context. The context is fetched asynchronously into the second RAG sub-system system.

The second RAG sub-system is an asynchronous RAG sub-system. This second RAG sub-system retrieves data asynchronously and updates the output whenever a new data flows into the system. The way it changes the output is by disabling a current output stream, and adding current output and adding new version of the context into a prompt, then asking an LLM to produce continuous output right after the current output. One benefit of this asynchronous RAG subsystem is that the subsystem provides timely response instead of waiting until all the memories are retrieved.

In some embodiments, the system may record scripts or action when a user interacts with a client device. For example, when the user operates actions in the screen, the perception is activated to understand the description of the location in the current event (like mouse clicking). The description is recorded into a script, for example: Open Chrome app, Click the address bar, Type www.google.com. The example actions that are created would include:
Open (app: “https://x.com”, waitAfter: 0.0)
Click (at: “search box”, message: “[Click] search box”)
RobustTyping (text: “simular”, withReturn: true)
Click (at: “people under home timeline”, message: “[Click] people”)
Click (at: “statictext text @simularai”, message: “[Click] simularai”)
Click (at: “follow”, message: “[Click] follow”)

In some embodiments, the system uses a ticket lock mechanism to process incoming messages for a given conversation ID in the correct order, and locks conversations while messages are actively processed. This allows the system to use multiple servers that run in parallel as replicated services. Clients do not necessarily need to address the same node when sending messages for a given conversation ID.

In some embodiments, the system provides optimized processing and functionality, such as:
Reduced Client-Side Load: By offloading computation and communication tasks to the cloud, we can minimize battery drain and CPU usage on user devices, ensuring smooth operation even as more complex functionalities are introduced.
Seamless User Updates: New actions, prompts, and features can be delivered from the server, eliminating the need for frequent app updates on the user's end and improving user experience.
Optimized App Size: The initial app download can be smaller by including only core functionalities. Users can then download additional actions on demand, reducing overall storage requirements on their devices.
Centralized Public Action Storage: A cloud-based service enables the creation and storage of public actions accessible to all users, fostering a collaborative environment and expanding the system's capabilities.

In some embodiments, the system performs actions. The smallest unit of the program which is used to build the blocks of Simulang. They can be either a control flow, a mouse or keyboard command, an app control, a function call, or an output control:
execution commands control the mouse or keyboard, such as clicking a tab or typing a message;
control flows provide decision-making statements that execute one or more commands based on situations. Examples of this type are sequential, try catch, if else, retry;
App controls provide app related operations, such as opening an app or waiting for an app to start;
functions that call other functions with or without body; and
Output controls are used to send notifications.

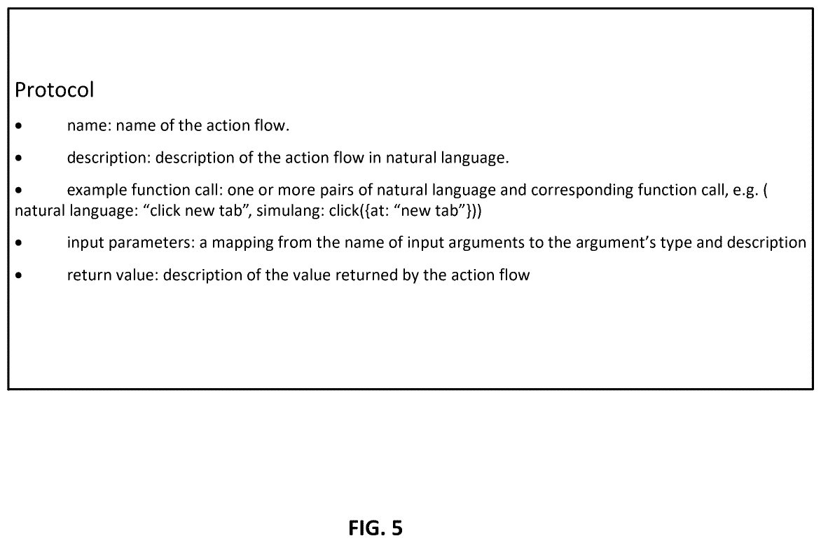

In some embodiments, the system performs action flows. An action flow is constructed from one or more actions. There are built-in action flows like click or type, but can also be constructed and shared by users. The protocol to define a custom Action Flow is illustrated in FIG. 5.

In some embodiments, the system uses a customized programming language referred to as Simulang. Simulang is a programming language that has no syntax to follow because it simply understands natural language. Simulang can break down instructions written in natural language into action flows and execute them. Simulang has the planner component to decide which action flows to invoke from the given instructions, and Controller component to parse and execute the action flows.

In some embodiments the system uses a protocol for defining new action flows for the Simulang, and a number of built-in action flows (i.e., primitive actions). Multiple different action flows may be performed by the artificial intelligence agent. Examples of built-in action flows include:

### Act

Completes a task specified in natural language, up to a maximum number of steps.

```
Returns: None
‘‘‘simulang
function Act({
  task: String = ″″,
  maxSteps: Int = 100
})
‘‘‘
```

### Open

Open or switch to an application.

```
Returns: None
‘‘‘simulang
function Open({
  app: String = null,
  url: String = null,
  waitForLoadComplete: Bool = true,
  waitTime: Int = 0
})
‘‘‘
```

### Type

Type using the keyboard.

```
Returns: None
‘‘‘simulang
function Type({
  text: String,
  withReturn: Bool = false,
  waitTime: Int = 0,
  waitForLoadComplete: Bool = false
})
‘‘‘
```

### Shortcut

Perform keyboard shortcut in the current application.

```
Returns: None
‘‘‘simulang
function Shortcut({
  key: String,
  cmd: Bool = false,
  ctrl: Bool = false,
  option: Bool = false,
  shift: Bool = false,
  waitTime: Int = 0
})
‘‘‘
```

### Click

Click on something, either specified by the ‘at’ argument or the ‘element’ argument.

Disambiguate by specifying the spatial relation between the target element and an anchor concept.

### Available Modes:

1. default is text-based grounding.

2. “textAndScreenshot”: grounding using both text and vision.

3. “vision”: vision-only grounding.

When using modes with vision, all other arguments are ignored except ‘withCommand’, ‘clickType’ and waits.

```
‘‘‘simulang
function Click({
  at: String = ″″,
  mode: String = ″″,
  clickType: String = “left”,
  withCommand: Bool = false,
  element: UIElement = null,
  spatialRelation: String = ″″,
  anchorConcept: String = ″″,
  prior: String = “none”,
  position: String = “center”,
  includeInvisible: Bool = false,
  waitForLoadComplete: Bool = false,
  waitTime: Int = 0
})
‘‘‘
```

### Move

Moves the cursor to an object. Disambiguate by specifying the spatial relation between the target element and an anchor concept.

All parameters besides ‘to’ have the same definition as those in the ‘Click’ action.

```
Returns: None
‘‘‘simulang
function Move({
  to: String = ″″,
  element: UIElement = null,
  spatialRelation: String = ″″,
  anchorConcept: String = ″″,
  prior: String = “none”,
  includeInvisible: Bool = false,
  waitForLoadComplete: Bool = false,
  waitTime: Int = 0
})
‘‘‘
```

### Drag

Drag on the screen, starting from where the mouse is located

```
Returns: none
‘‘‘simulang
function Drag({
  to: String = ″″,
  element: UIElement = null,
  destinationApp: String = null
})
‘‘‘
```

### Scroll

Scroll on the screen in a specified direction.

```
Returns: None
‘‘‘simulang
function Scroll({
  direction: String = ″down″,
  distance: Int = 200
})
‘‘‘
```

stateSatisfies

Checks if the current state satisfies a natural language description.

Returns: True if all the concepts can be found on the current visible
screen, else False.
‘‘‘simulang
function stateSatisfies({
condition: String
})
‘‘‘

pageContent

Gets a JSON object containing the structural text content and base64 encoded image of the current screen.

This object can be sent to a vision-language model for answering questions about the current screen.

Returns: A JSON dictionary with the following fields:
- text: A text description of the current web page;
- imageFilePath: temporary location in memory of the screenshot
(accessible by ‘ask‘).
‘‘‘simulang
function pageContent({
})
‘‘‘

ask

Runs a large vision-language model on the given input prompt string and a JSON dictionary context.

Often used after pageContent( )

Returns: String response from a large vision language model.
‘‘‘simulang
function ask({
prompt: String, context: [[String: String]]
})
‘‘‘

### Wait

Put Agent into sleep state for a certain amount of time.

Returns: None
‘‘‘simulang
function Wait({
waitTime: Int, unit: String = ″s″
})
‘‘‘

### Respond

Returns: None
‘‘‘simulang
function Respond({
message: String, requireConfirm: Bool = false
})
‘‘‘

### Copy ToClipboard

Copies a String to clipboard.

Returns: None
‘‘‘simulang
function CopyToClipboard({
text: String
})
‘‘‘

### GetFromClipboard

Get the content of the current clipboard.

Returns: Content of the current clipboard
‘‘‘simulang
function GetFromClipboard({
})
‘‘‘

### SaveScreenshot

Takes a screenshot of an element on the screen or the whole screen, and saves the screenshot as a PNG to a file.

```
Returns: None
‘‘‘simulang
function SaveScreenshot({
  element: UIElement = null,
  fileName: String = null,
  directory: String = null
})
‘‘‘
```

### ScreenshotToClipboard

Take a screenshot of an element or the current page and save it to the system clipboard

Returns: None
''simulang
function ScreenshotToClipboard({
element: UIElement = null
})
‘‘‘

### ReadFile

Read the contents of a file whose location is specified by ‘path’.

Returns: Contents of the file as a String
‘‘‘simulang
function ReadFile({
path: String
})
‘‘‘

### WriteToFile

Writes the given text to a file. If the file already exists, then appends text to it, with an option to overwrite the existing content.

Unless specified path, writes to/Library/Caches/com.simular.Simular-Pro/SimularActionResult/Will throw an error if there is an existing non-folder file named SimularActionResult

```
Returns: None
‘‘‘simulang
function WriteToFile({
  text: String,
  path: String? = ″SimularActionResult.txt″,
  overwrite: Bool = false
})
‘‘‘
```

### GetGoogleSheetCell Value

Gets the value of a cell in a Google Sheet.

Returns: Value of the cell
‘‘‘simulang
function GetGoogleSheetCellValue({
cell: String
})
‘‘‘

### SetGoogleSheetCell Value

Sets the value of a Google Sheet cell.

Returns: None
‘‘‘simulang
function SetGoogleSheetCellValue({
cell: String, value: String
})
‘‘‘

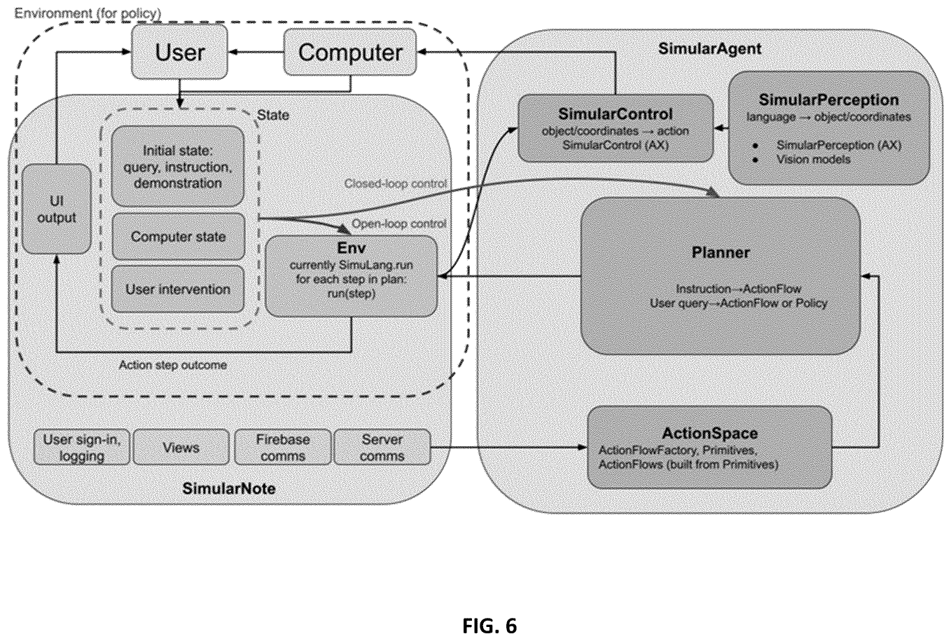

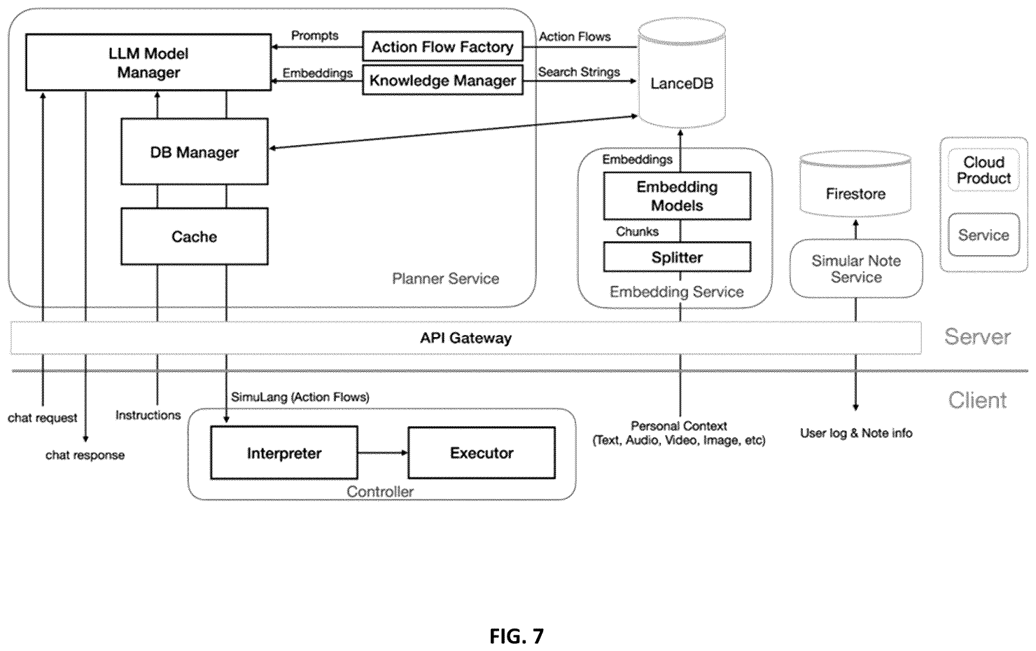

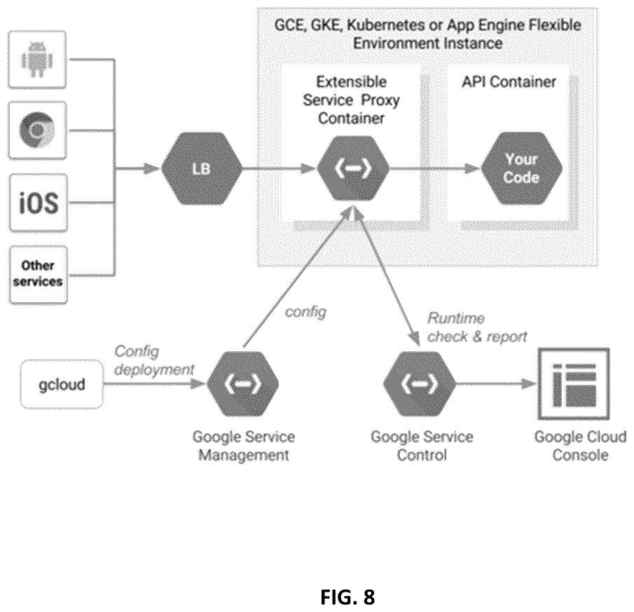

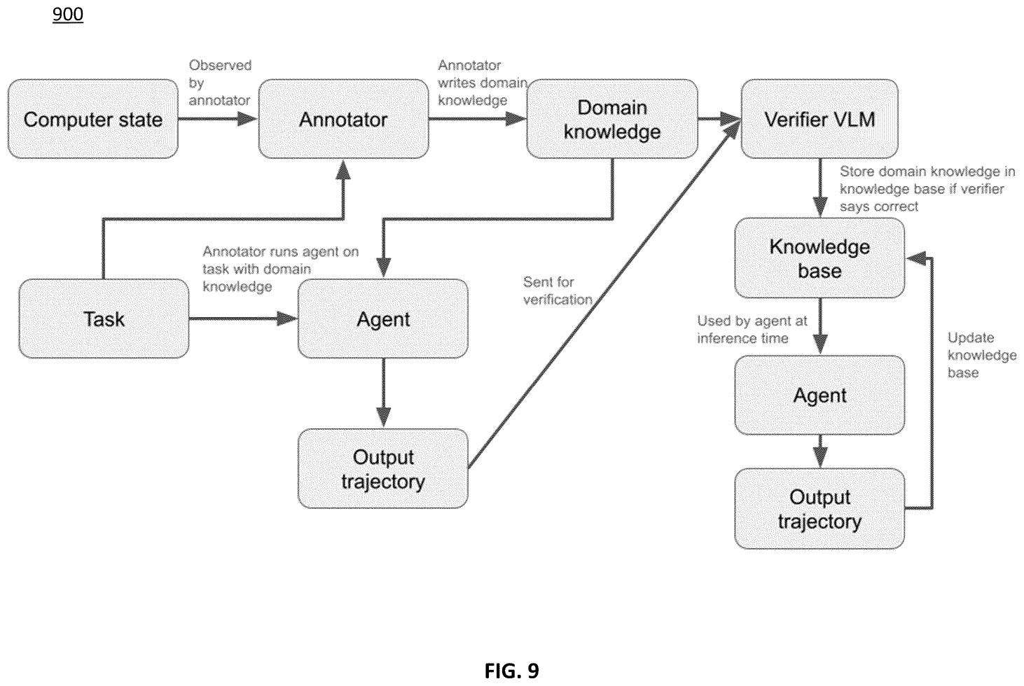

Referring to FIGS. 6-8, the diagrams describe aspects of the system architecture in more technical detail than FIG. 1A.

In some embodiments, the system interacts with and provides generated prompts as input to one or more LLMs. For example, some of these LLMs include Llama3-70B, Llama3-70B (fast), GPT-3.5, and/or Gemma 2-B).

The system's servers may be divided into three services, which may be served, for example, on a Google Kubernete Engine (GKE) to manage deployment, scaling, and routing automatically. Even though the system's servers may be deployed on a Google Cloud and utilize Google's cloud services, the server can be deployed on any cloud platforms (e.g. Amazon AWS, Microsoft Azure) as all should have equivalent services.

An API gateway serves as the entry point for external communication with the system's services. This gateway leverages a combination of technologies to ensure secure and controlled access.

An Embedding Service enables Retrieval-Augmented Generation (RAG) for enhanced LLM responses within the Planner service. It acts as a knowledge encoder, transforming various types of information into a format suitable for similarity search. This service can process diverse data sources, including text, images, audio, and video. The service generates vector representations (embeddings) for each data type. These embeddings are then stored within a dedicated vector database. The Planner service can then leverage these embeddings during RAG-based LLM processing to retrieve relevant knowledge elements and personalize responses based on the user's specific context.

Referring to FIG. _, an example process 900 for a for updating a knowledge base by the agent. In some embodiments, the system performs a process where a computer state is observed by an annotator module. The annotator module writes domain knowledge to a domain knowledge repository. The annotator runs an agent with one or more tasks and determines and determines an output trajectory. A verifier VLM stores domain knowledge in the knowledge base if the verifies that the output trajectory is correct. A current knowledge base is used by the artificial intelligence agent to determine another output trajectory (which may be used to update the knowledge base).

In some embodiments, the computer system performs the RAG pipeline via four general steps of (1) Query Formulation, (2) Knowledge Retrieval, (3) Knowledge Integration and (4) Input Augmentation. Typically, an LLM is not pre-trained on the data of real world operating system applications. As such, the LLM lacks domain knowledge when performing desktop task. The described RAG pipeline provides a process to equip or provide the personal agent with domain knowledge retrieved from online Internet accessible sources and episodic memory (e.g., past historical recording information and/or data about similar task that were previously performed by a computing device).

In some embodiments, for the operation of Knowledge Base Construction, the system stores the query and the summarized experience as a key-value pair into KB. For the example the Key is the Formulated Query (task instruction+initial state), and the Value is the Summarized Experience.

In some embodiments, for the operation of Similarity-based Retrieval, the system retrieves from the knowledge based on the similarity of embeddings (e.g., using text-embedding-3-small).

### Insert Section on Human-Annotated Domain Knowledge Database

### Input Augmentation

In the Input Augmentation step, the system augments the original task instruction with the integrated knowledge for planning. In the Input Augmentation step, the system Augments the original task instruction with the integrated knowledge as context.

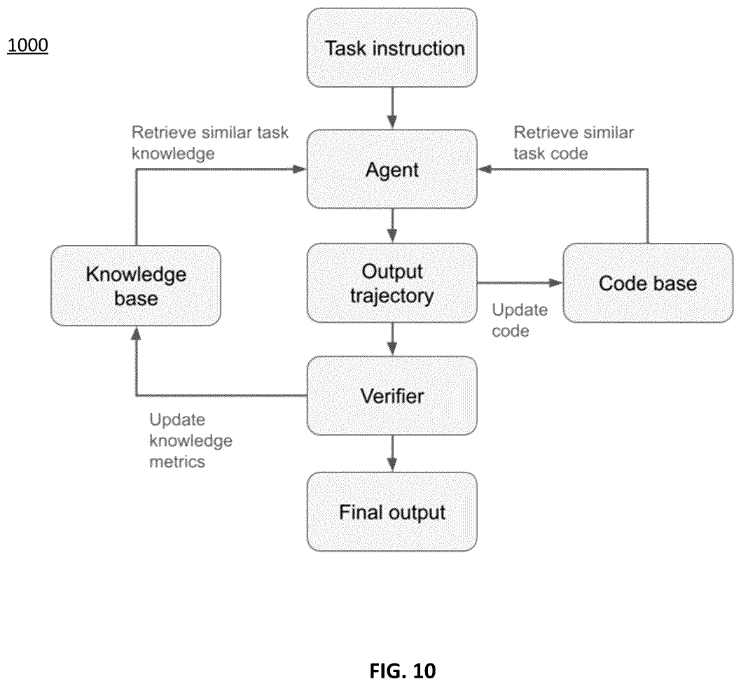

Referring now to FIG. 10, a diagram illustrates a method a process for performance of task instructions by the artificial intelligence agent. The artificial intelligence agent receives one or more task instructions. The agent determines an output trajectory. In one path, a code base and updated and the agent retrieves a similar task code. In another path, a verifier performs operations and a knowledge base is updated where the agent retrieves similar task knowledge. This iterative process provides continuous lifelong learning operations performed by the system.

In some embodiments, over the course of time, the system performs multiple task instructions. The system is configured to continuously learn and update the knowledge base. For example, for each task instruction, the system performs operations with an artificial intelligence agent. An output trajectory is summarized and provided to the knowledge base. A self-evaluation agent, if not successful interacts with the Knowledge Base and a same task experience is retrieved and provided to the artificial intelligence agent. If successful or reaching max_steps, a final output is provided by the self-evaluation agent.

In some embodiments, the self-evaluation agent is performed by the system where the self-evaluation agent is a state-aware self-evaluating agent. For example, given the task instruction, the observations (e.g., first and last trees of the knowledge based and the retrieved information), and the whole trajectory of performed actions, the artificial intelligence agent determines whether the task is completed or not. This is used to label the past experience in both random exploration and lifelong learning. In addition to the using the above described information, the artificial intelligence agent may also determine to write programming code (e.g., in the form of Python scripts) to interact with the computing environment of a client device, and the use the feedback from the environment to assist in the determination or judgement.

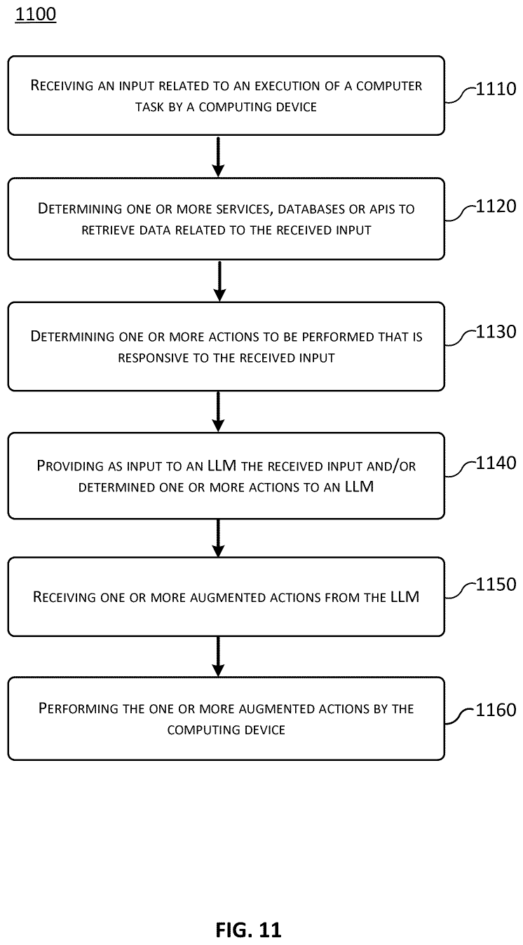

FIG. 11 is a flow chart illustrating an exemplary method 900 that may be performed in some embodiments.

In step 1110, the system receives an input via a user interface displayed via a computing device. For example, a user may input in natural language one or more tasks or operations to be performed by the computing device.

In step 1120, the system determines one or more services, databases and/or application programming interfaces to retrieve data related to the received input. For example, the system may use these additional sources of data or information may be helpful or relevant to allow the personal agent of the system to perform tasks or operations by the computing device.

In step 1130, the system determines one or more actions to be performed by the computing device that is respective to the input received from the user. The system may use one or more LLMs and the generated prompts to determine what operations may be relevant to the performance of the request task. In some examples, a series of tasks or operations may have previously been performed and the instructions to perform the task or operations were previously stored by the computing device. In such instances, the system may use the previously stored commands to perform the task or operations and forgoes the steps 1140-1160.

In step 1140, the system provides as an input to an LLM the received input and the determined one or more actions to the LLM. The LLM generates an augmented set of the one or more actions. For example, the LLM may add additional operations, data values and other information that may be helpful or necessary such that the computing device may perform the determined one or more actions.

In step 1150, the system receives the augmented one or more actions from the LLM.

In step 1160, the system causes the computing device to perform one or more augmented actions generated by the LLM.

Structural Grounding Expert. Another category of grounding bottleneck involves locating elements in spreadsheets and tabular content. Since spreadsheet cells can be stretched and squeezed to arbitrary sizes, and translating the table can change the starting position of the rows and columns, grounding on tabular data remains a significant challenge. To overcome this limitation and ensure precise grounding in tabular UI elements, the Structural Grounding expert takes a dictionary of <“cell”:“value”> mapping and programmatically updates the content of the corresponding cells. The structural grounding expert can take multiple cells, even entire rows, columns, or tables, as input and update them all at once, allowing both reliable and faster grounding for structured data.

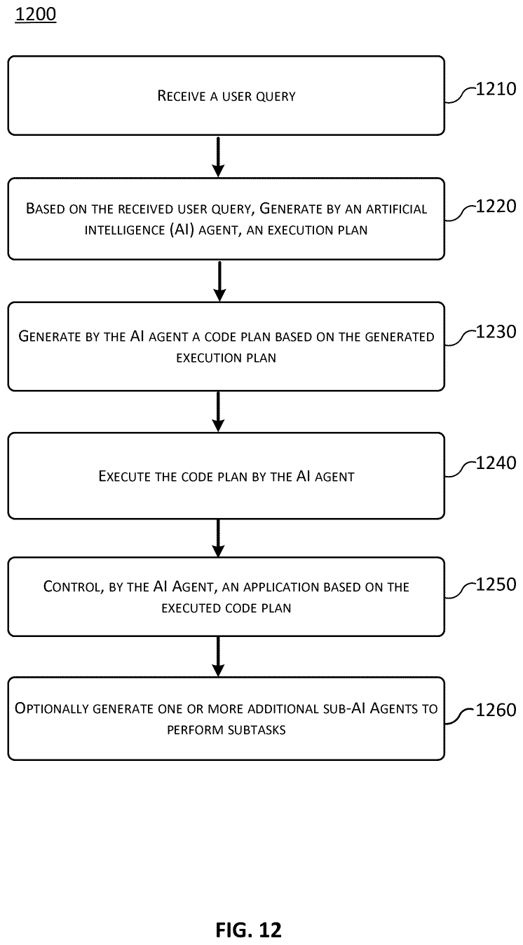

FIG. 12 is a flow chart illustrating an exemplary method 1000 that may be performed in some embodiments.

In step 1210, the system receives a user query. In some embodiments the query is received from a user or other system, or artificial intelligence agent. In some embodiments, the query includes text in the form of natural language. For example, the user may input a search into an input field asking the artificial intelligence agent to place a particular product into a shopping cart.

In step 1220, the system generates, by an artificial intelligence agent (such as Artificial intelligence agent), an execution plan to execute the received query via a computer system. In some embodiments, the system uses one or more large language models to generate an execution plan. The execution plan is a high level

In step 1230, the system generates, by the artificial intelligence agent, a code plan based on the execution plan. The execution plan includes the generation of a textual explanation of what the artificial agent understands what the artificial intelligence agent is going to do based on the user query. The explanation may be display via a user interface to the user. Additionally, the execution plan includes a code plan comprising a list of tasks that are to be performed by the artificial intelligence agent. In some embodiments, the list of tasks comprise computer code instructions or macros that are performed by the artificial intelligence agent. These tasks control and/or perform functions as to an application, browser, software and/or an operating system of a computing device. The system uses one or more large language models (LLMs) to generate the list of the tasks based on one or more prompts that instruct the LLMs to generate code to carry out the execution plan. In some embodiments, the system generates a code plan in the form of Javascript that is particularly suited for interaction with a web browser.

In step 1240, the system executes the code plan by the artificial intelligence agent. The code plan includes a listing of tasks (e.g., specific Javascript code instructions) that are performed by the artificial intelligence agent. In some embodiments, the artificial intelligence agent sequentially executes the task (for example, using a Javascript runtime compiler).

In some embodiments, the system provides a user interface that displays a description of each of the tasks of the tasks (e.g., subgoals) of the plan that are being performed. The displayed description may be in an description that is a less technical description that the actual code or commands that is being performed by the

In step 1250, the artificial intelligence agent controls an application based on the executed code plan. The executed task then performs an operation, control or some function with respect to the web browser. The system determines whether the task was successfully executed or not. If the current task is executed successfully, then the next task in the code plan is executed by the artificial intelligence agent (and so on, and so forth), until the final task of the code plan is performed by the artificial intelligence agent.

In step 1260, the artificial intelligence agent optionally generates one or more sub-AI agents to perform subtasks for a task of the code plan. In some embodiments, the artificial intelligence agent determines that to perform a task of the code plan, that a sub-agent is required to perform a particular task. In some modes of operation, the artificial intelligence agent instantiates a sub-agent to perform a sub-code plan. For example, the parent artificial intelligence agent may generate a prompt and request that one or more LLMs generate a list of tasks to perform a particular task from the code plan. The artificial intelligence agent may take a specific task from the code plan, and generate, via the one or more LLMs, a sub-code plan to be performed by a sub-agent. In some embodiments, the sub-code plan includes a task list of one or more computer code instructions, computer commands, macros etc. that are performed by the sub-AI agent.

A generated sub-AI agent may generate one or more sub-sub-AI agents to perform sub-sub-task for a sub-task of a sub-code plan. In other words, an instantiated sub-agent may instantiate its own sub-agent to create a new sub-code plan to perform a task provided to it by a parent sub-agent that instantiated the sub-agent.

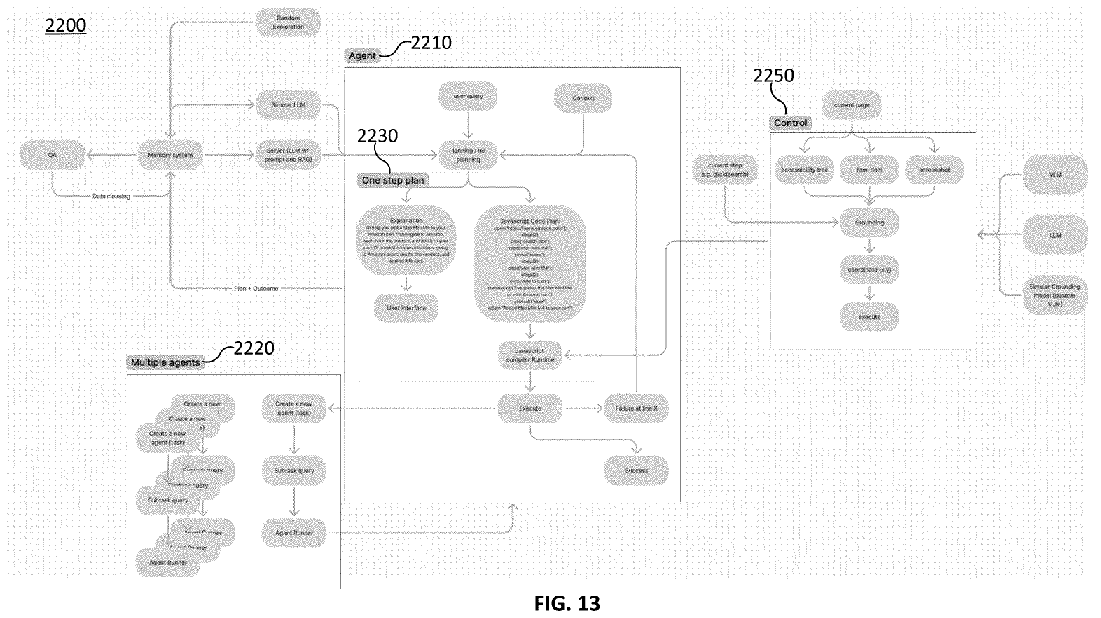

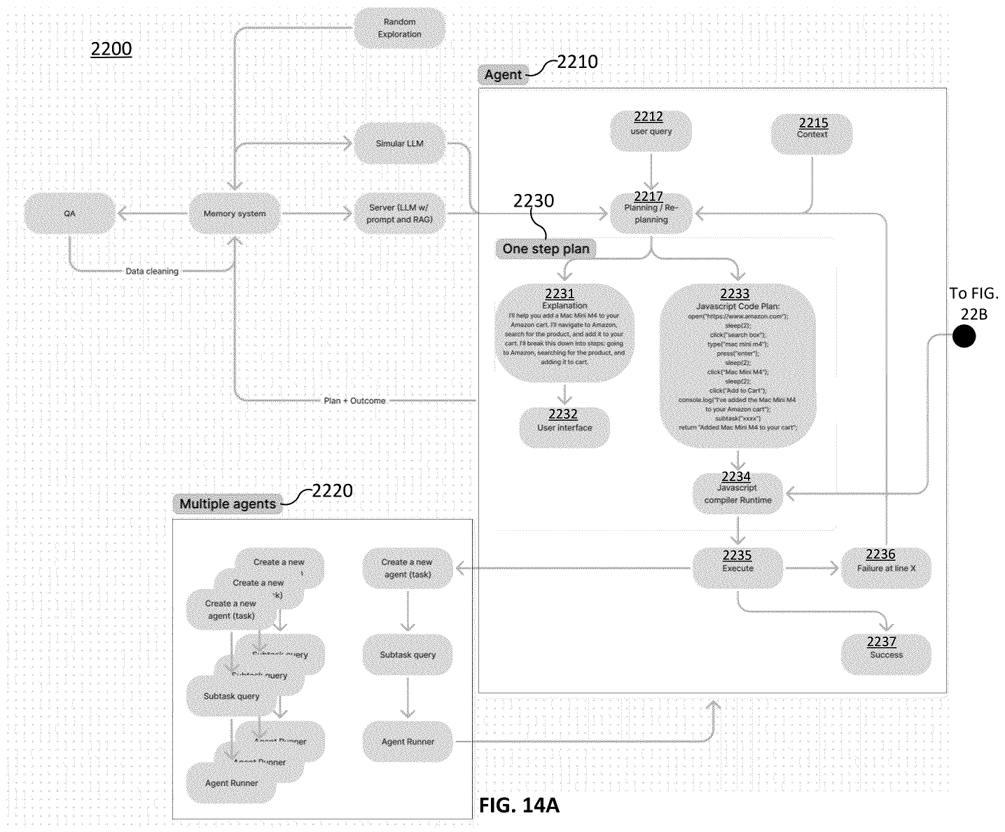

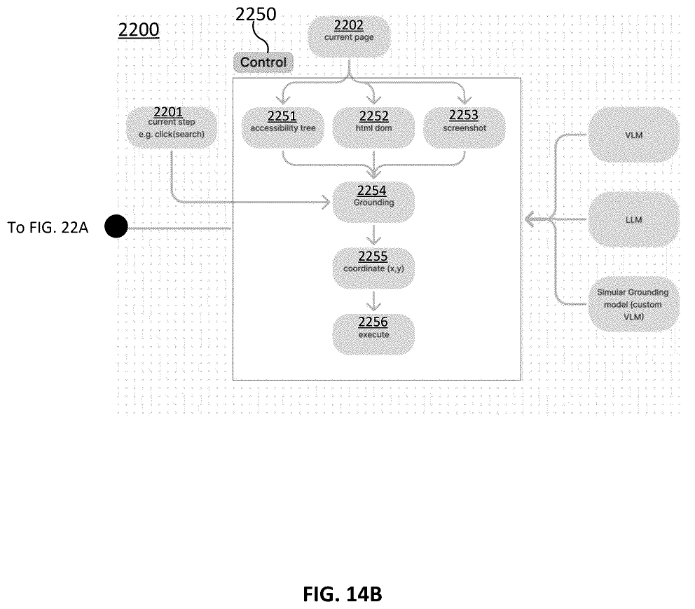

FIG. 13 is a diagram illustrating and example process using an artificial agent to perform a user query according to some embodiments. FIGS. 14A-14B are diagram of FIG. 13 split into two figures.

The method described with respect to FIG. 13 may be further understood with example process 2200 depicted in FIGS. 13, 14A-14B. The process 2200 performed by the system shows an artificial intelligence agent 2210 performing operations of planning/replanning to generation an execution plan 2230. Additional context 2215 may be used by the artificial intelligence agent to perform a planning/replanning process to generate the execution plan 2230. The execution plan includes the generation of a textual explanation of what the artificial agent understands what the artificial intelligence agent is going to do based on the user query. The explanation may be display via a user interface to the user. Additionally, the execution plan includes a code plan 2233 comprising a list of tasks that are to be performed by the artificial intelligence agent. In some embodiments, the list of tasks comprise computer code, instructions, commands and/or macros that are performed by the artificial intelligence agent. The generated code plan is created by the artificial intelligence agent 2210 to carry out a received user query 2212.

In the example, code plan 2233 a task list includes a series of Javascript commands that are performed by the artificial intelligence agent. In this example, the artificial intelligence agent 2210 consecutively performs each of the commands using a control process 2250 for interacting and controlling a web browser page. While the example is specific to a web browser and using an accessibility tree 2251, the HTML DOM (document object model) 2252 and a screenshot of a particular web page, the control process can be configured for use with an application or other software with the use of the accessibility tree 2251 or the HTML DOM 2252. The accessibility tree is a hierarchical representation of a webpage's content.

The system uses the control process to perform a task from the code plan with respect to the web browser. For those Javascript commands that use a particular UI component to interact with the web browser, such as a button, or other user interface control, the artificial intelligence agent may obtain a screen shot 2253) of a web page and provide the screen shot to one or more LLMs or VLMS to identify a coordinate location 2255 of the user interface control of where to provide a selection or clicking of a mouse point or provide a touch input to the identified coordinate location. The system performs a grounding process 2254 to identify the location of a user interface control or element where the task is to be performed. The system may use one or more VLMs, LLMs where these machine learning models are configured to identify the location and return pixel coordinates.

For example, the code plan may include a click (“search box”). To perform this task, the artificial intelligence agent provides the command to the control process 2250. The current step 2201 of the code plan is performed by the control process 2250 on a current page of the web browser (which was opened by the artificial intelligence agent using an open command with a website URL).

In some embodiments, the system may generate operating system commands to instruct the movement of a mouse pointer to a location on a screen such that the mouse pointer is positioned over a location of a user interface control of an application. Additionally, the system may generate operating system commands to instruct the input of text into a text input field. The system may generate commands to cut, copy, paste and delete text in an application.

The control process obtains an image of the web page. The system sends the obtained web page image to the one or more LLMs and/or VLMs to obtain a coordinate location of the “search box”. For example, the system may generate a prompt instructing the one or more LLMS and/or VLMs to identify a pixel coordinate location of a “search box” in the image. The returned pixel coordinate location is then used by the system to perform the perform a click command at the pixel coordinate location.

In some situations, the artificial intelligence agent generates a code plan that includes a series of tasks that are to be performed by the artificial intelligence agent. However, in some instances an executed task 2235 of the code plan 2233 may fail 2236. In cases where the a task of the code plan 2233 fails where the artificial intelligence agent is not able to perform the computing task, the computing task fails (such as when an error code is generated by the acted upon application, or the a time out period has occurred where the application acted upon is non-responsive, or that some other situation occurs where the application cannot perform the task) then the artificial intelligence agent 2210 may need to replan some or all of the code plan 2233. In other words, where the artificial intelligence agent cannot perform one or more computing tasks, then the artificial intelligence agent 2210 performs the planning/replanning process 2217 again to generate a new code plan.

In some embodiments, the artificial intelligence agent generates a prompt with a listing of the particular task that could not be performed, and request that the one or more LLMs generate a new task to perform the task. For example, the one or more LLMs may generate different computer code commands to perform the task. The artificial intelligence agent 2210 then may try to perform the newly generated computer code command. If the new task is successfully performed, then the remaining prior generated tasks in the code plan, then can be performed. If the new task fails, then the artificial intelligence agent 2210 may try to completely regenerate the code plan. The artificial intelligence agent 2210 may provide to the one or more LLMs a listing of the current code plan with an indication that the current code plan did not work. The artificial intelligence agent 2210 may request that the one or more LLMs generate a new or revised code plan. The new or revised code plan includes a series of command and/or computer instructions that are different than the first or originally generated code plan. The artificial intelligence agent 2210 then executes the code plan plane as described herein.

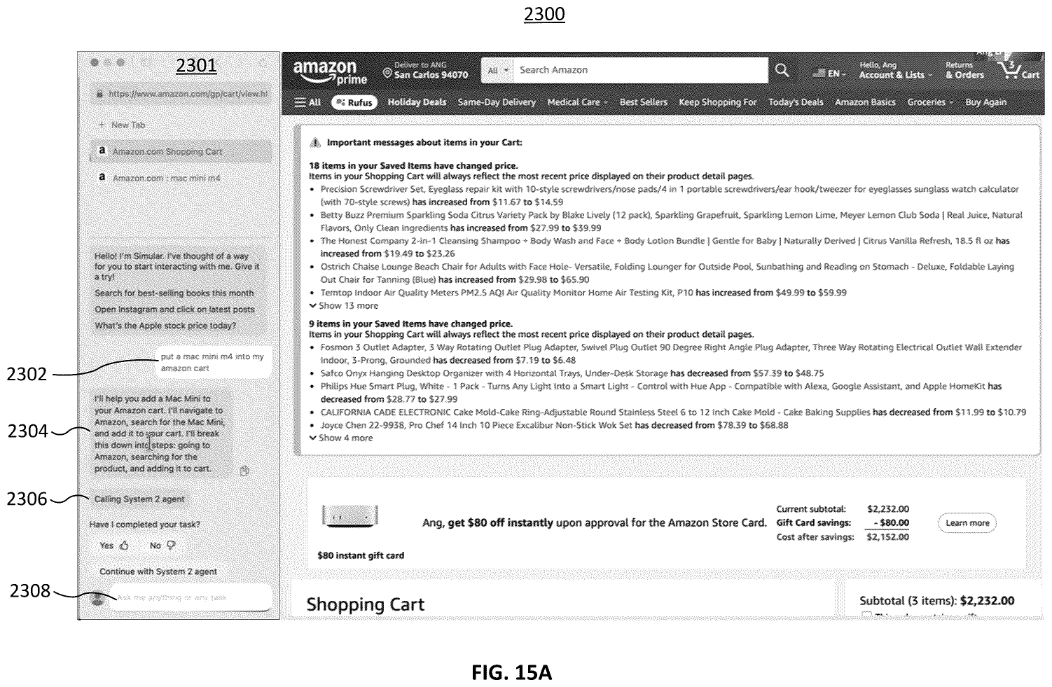

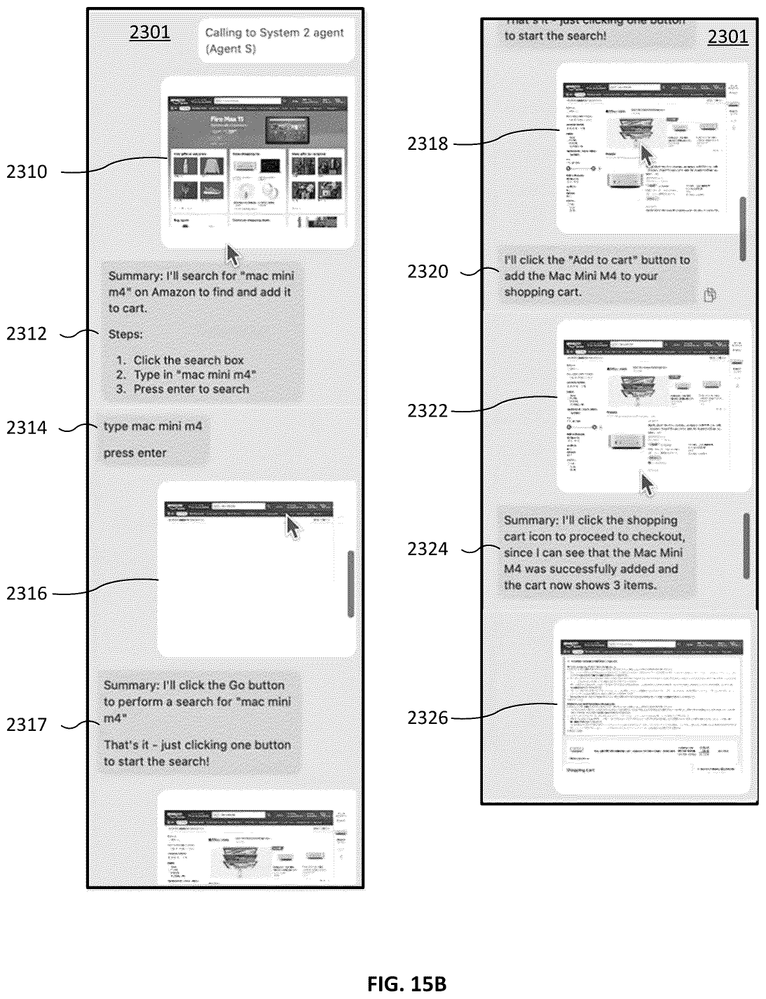

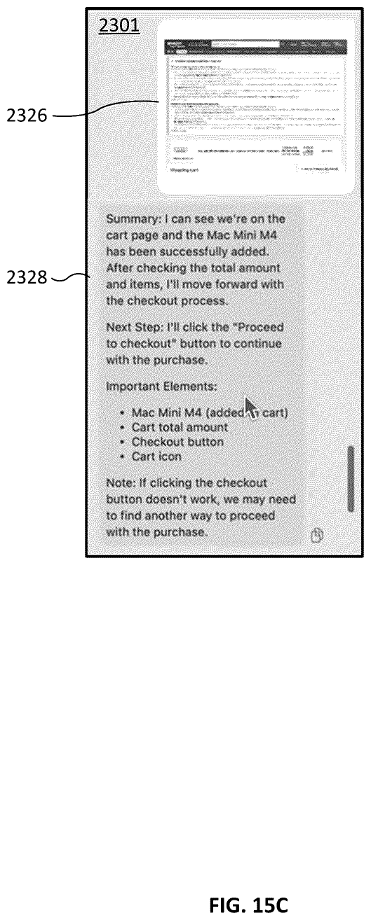

FIGS. 15A-15C are diagrams illustrating an exemplary user interface 2300 according to some embodiments. The user interface 2300 includes a chat interface 2301 where the artificial intelligent agent may provide text and image information to a user. The chat user interface include a input field 2308 where a user may input text (such as a query or other instructions) to be processed and executed by the artificial intelligence agent.

These figures provide an example interaction between the artificial intelligence agent and a user in the context of a web browser. A web browser may be configured to interact with the artificial intelligence agent (such as through a web browser plugin).

A request 2302 was made by a user for the artificial intelligence agent to place a product in a shopping cart. The artificial intelligence agent receives the request and response with a message 2304 about helping the user with the request. The system continues with the processing of the request using the Artificial intelligence agent artificial intelligence agent 2306.

The artificial intelligence agent obtains an image of the main page of the ecommerce website 2310.

The artificial intelligence agent generates an execution plan and a code plan to carry out the user's request. The artificial intelligence agent provides a message 2312 describing a summary of an execution plan and provides a detail listing of the steps (e.g., tasks) that are to be performed by the artificial intelligence agent. As described above, the artificial intelligence agent uses one or more LLMs to generate the execution plan and the code plan. The image obtained of the main page of the ecommerce website 2310 is used by the artificial intelligence agent as content and to aid in the creation of the execution plan and the code plan.

The artificial intelligence agent begins execution of the steps of the execution plan. The artificial intelligence agent provide a message of the steps being performed 2314. While the artificial intelligence agent is interacting with a web page, application, software of an operating system, the artificial intelligence agent will obtain a new image of a user interface where the user interface has d in response to an action performed by the artificial intelligence agent. The artificial intelligence agent detects that a new page 2316 is being loaded in response to the artificial intelligence agent completing the steps of clicking the search box, typing in the words “mac mini m4” and then causing an keyboard command of pressing enter. The artificial intelligence agent obtains an image of the newly loaded web page.

The artificial intelligence agent will next evaluate the newly loaded web page and determine a sub-plan and sub-code plan to interact with the new web page 2316. The artificial intelligence agent obtains an image of the newly loaded web page. The artificial intelligence agent will next evaluate the obtained image and/or the DOM structure and HTML of the newly loaded web page and determine another execution plan and code plan to interact with the new web page. The artificial intelligence agent provides a message 2317 describing a summary of the sub-plan and provides a detail listing of the steps (e.g., tasks) that are to be performed by the artificial intelligence agent. Here the artificial intelligence agent generates a sub-code plan that includes the commands to click a search button. The artificial intelligence agent uses a grounding process where the image of the new web page is evaluated by the system and a pixel coordinate location of the search button was identified. For example, the sub-code plan may include a command or computer instructions to move a mouse pointer to the pixel coordinate location and click on the web page at the pixel coordinate location. Alternatively, the sub-code plan may include Javascript command to click on an object of the web page.

In response to executing the current sub-code plan, a new web page 2318 is loaded into the web browser, ad the artificial intelligence agent will next evaluate the newly loaded web page 2318. The artificial intelligence agent determines another sub-plan and sub-code plan to interact with the new web page 2318. The artificial intelligence agent obtains an image of the newly loaded web page 2318. The artificial intelligence agent will next evaluate the obtained image and/or the DOM structure and HTML of the newly loaded web page 2318 and determine another sub-plan and sub-code plan to interact with the new web page. The artificial intelligence agent provides a message 2320 describing a summary of the sub-plan and provides a detail listing of the steps (e.g., tasks) that are to be performed by the artificial intelligence agent. Here the artificial intelligence agent generates another sub-code plan that includes the commands to click an “Add to cart” button to add a Mac Mini 4 to a shopping cart. The artificial intelligence agent used a grounding process where the image of the new web page 2318 is evaluated by the system and a pixel coordinate location of the “Add to cart” button was identified.

In response to executing the current sub-code plan, a new web page 2322 is loaded into the web browser, the artificial intelligence agent will next evaluate the newly loaded web page 2322 and determine yet another sub-plan and sub-code plan to interact with the new web page 2322. The artificial intelligence agent obtains an image of the newly loaded web page 2322. The artificial intelligence agent will next evaluate the obtained image and/or the DOM structure and HTML of the newly loaded web page and determine another sub-plan and sub-code plan to interact with the new web page 2322. The artificial intelligence agent provides a message 2324 describing a summary of the next sub-plan and sub-code plan provides a detail listing of the steps (e.g., tasks) that are to be performed by the artificial intelligence agent. The sub-code plan is then performed by the artificial intelligence agent and a new page 2326 is loaded.

In response to executing the current sub-code plan, a new web page 2322 is loaded into the web browser, and the artificial intelligence agent will next evaluate the newly loaded web page 2322. The artificial intelligence agent determines yet another sub-plan and a sub-code plan to interact with the new web page 2322. The artificial intelligence agent obtains an image of the newly loaded web page 2322. The artificial intelligence agent will next evaluate the obtained image and/or the DOM structure and HTML of the newly loaded web page and determine another sub-plan and sub-code plan to interact with the new web page 2322. The artificial intelligence agent provides a message 2324 describing a summary of the next sub plan a provides a detailed listing of the steps (e.g., tasks) that are to be performed by the artificial intelligence agent. The current sub-code plan is then performed by the artificial intelligence agent and a new page 2326 is loaded.

In response to executing the current code plan, a new web page 2326 is loaded into the web browser, the artificial intelligence agent will next evaluate the newly loaded web page 2326 and determine yet another sub-plan and sub-code plan to interact with the new web page 2326. The artificial intelligence agent obtains an image of the newly loaded web page 2326. The artificial intelligence agent will next evaluate the obtained image and/or the DOM structure and HTML of the newly loaded web page and determine another execution plan and code plan to interact with the new web page 2326. The artificial intelligence agent provides a message 2328 describing a summary of the next execution plan and code plan provides a detail listing of the steps (e.g., tasks) that are to be performed by the artificial intelligence agent.

The artificial intelligence agent continues with the generation of additional sub-plans and sub-code plans to carry out the execution plan. As illustrated by the example of interacting with a dynamic web page, in some embodiments, the artificial intelligence agent generates a new sub-plan and sub-code plan by evaluating a new web page. The new web page provides context and information such that the artificial intelligence agent can determine what actions are needed such that the execution plan may be performed by the artificial intelligence agent. In some embodiments, the system performs the steps of:
User submits task.
Agent runs task.
If execution (control and code) success, run model verification.
Write model verification result to some field (currently run_status, but need refactoring) in document <session_id> in Firebase unverified collection.
Upload (task, messages, screenshots, url, . . . ) to AWS S3 simularbrowser-annotation/trajectories/<session_id> for human verification.
Mark documents that need human verification: 1-click.
Based on some criteria (TBD, e.g., agent mode, task distribution, . . . ), mark tasks as todo for human verification.
Update the <session_id> unverified document in Firebase human_verifier_status=todo.
Assign for human verification: 1-click.
Based on some criteria (TBD), assign the <session_id> with human_verifier_status=todo to a specific human verifier.
Set human_verifier_status=“assigned”.
Also create “human_verifier_result”: [String: Any] dictionary with <annotator_id>: “assigned” (we may need multiple human verification for one trajectory).
Human verifier logs into some verification webportal, fetches the assigned trajectories from S3, clicks success/failure/impossible.
write to Firebase unverified document human_verifier_result [<annotator_id>]=success/failure/impossible.
If enough human verifiers are done, write to Firebase unverified document human_verifier_status=“done”.
Mark documents that need knowledge annotation: 1-click.
Based on some criteria (TBD, e.g. model+human verification result), assign task to knowledge annotator (keep it simple, only one knowledge annotation per task.
Knowledge annotator writes knowledge, runs agent, then model verifier always at the end.
If model verifier says success, annotator can upload knowledge.
If model verifier says failure, annotator can disagree and override. If override, then this is a human verification datapoint. Upload trajectory to S3, create a new document in Firebase unverified collection, with human_verifier_status=“done” and human_verifier_result[<annotator_id>]=success.

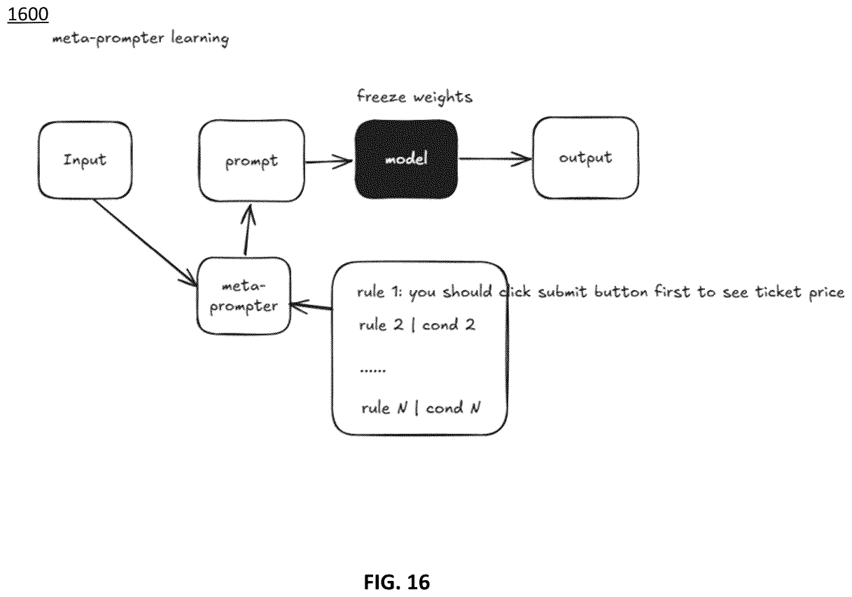

FIG. 16 is a diagram illustrating training and continuous learning model process 1600. The process includes a meta-prompter that receives an input and a set of one or more rules. The meta-prompter generate a prompt based on these input and inputs the prompt into a trained mode to generate an out. In some embodiments, the machine learning model does not change the weights of the model. Here the trained machine learning model is a static model and only the prompt changes. The system generates different types of prompts to get different output (e.g., different results from the model). For each state, multiple rules may be applicable. In some embodiments, a rule=(state, task)→rule description. In some embodiments, a state is a domain name (e.g., URL) with a current page context. The particular rule is what action is to be performed.

For example, there can be a rule for that state “Expedia.com” where the rule describes “you need to click on the text field to input destination for booking”. So when, the system is navigation on the web page Expedia.com, the system retrieves from the rule dictionary (e.g., the repository of rules), all of the rules associated with the state “expedia.com”. All of these retrieved rules then are formed into a prompt.

The meta-prompter receives one or more rules and generates a prompt for input into the model. In some embodiments, the system includes a dictionary of rules that can be provided to the meta-prompter. In some embodiments include a rule description. The rule can include a state of an object or a reference. For example, the state of an object may be a web page reference and/or other uniform resource locator reference. In some embodiments, the state is a screen or other user interface. The dictionary of rules may be selected based on the object or a reference. The system then generates a listing of rules to be included in the prompt. For example, the system may select rules 1, 2, 7, 10 etc., and then generate a prompt using a rule description for each of the selected rules which each includes task.

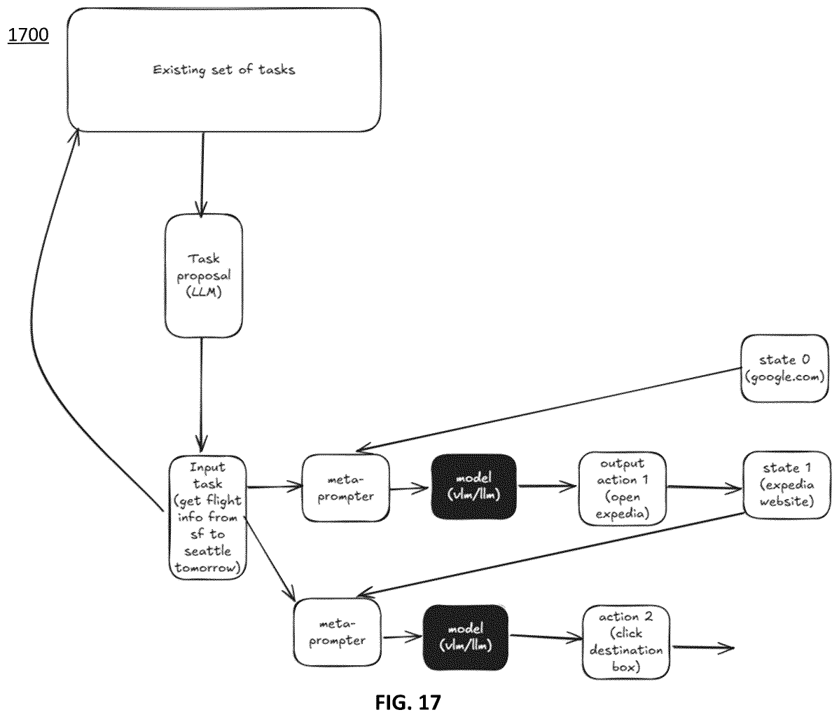

FIG. 17 is a diagram illustrating a method 1700 of processing an existing set of tasks via the trained one or more machine learning models. The existing set of tasks then are formulated into a prompt. The meta-prompter takes each of the tasks and inputs the task into the trained machine learning model which outputs an action. Multiple tasks are input to the trained machine learning model.

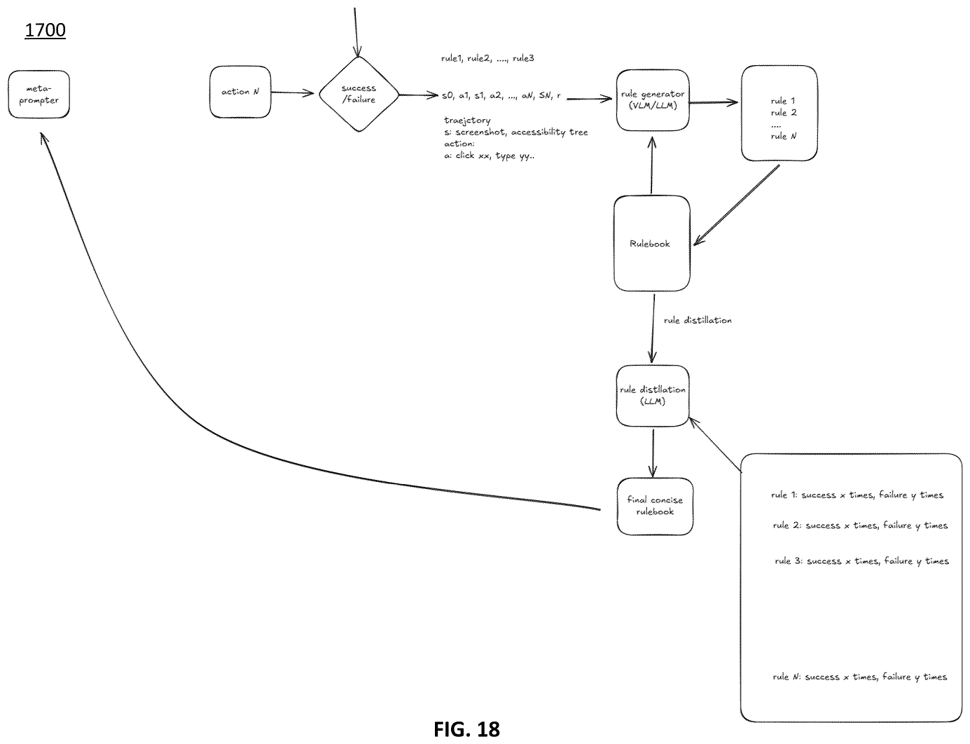

FIG. 18 is a diagram illustrating continued processing from FIG. 17. The system determines whether a particular task or action is successful or not. The system then updates the rule dictions with rules that are determined to be valid or those rules that are deemed to work. The system then uses a final rule book of rules that have been deemed to be successful. In some embodiments, a particular rule is distilled to determine whether the rule successfully performs a task a number of times and/or whether the performance of the task fails number of times. If the rule is successfully performed a predetermined number of times, then the rule may be placed into the final rulebook. The final rulebook then is used to process the states (e.g., a URL reference). This process as depicted in FIGS. 13-15 creates a set of rules with tasks or actions that are likely to be completed with respect to a particular state (e.g., a URL reference).

In some embodiments, a new state may be selected by the system. For example, the system may select a new state where a rule has not been already defined. In such cases, the system may select one or more preexisting rules that could be applicable to the new state, and then successively test the various preexisting rules to see if the rules would be successfully completed when applied to the new state.

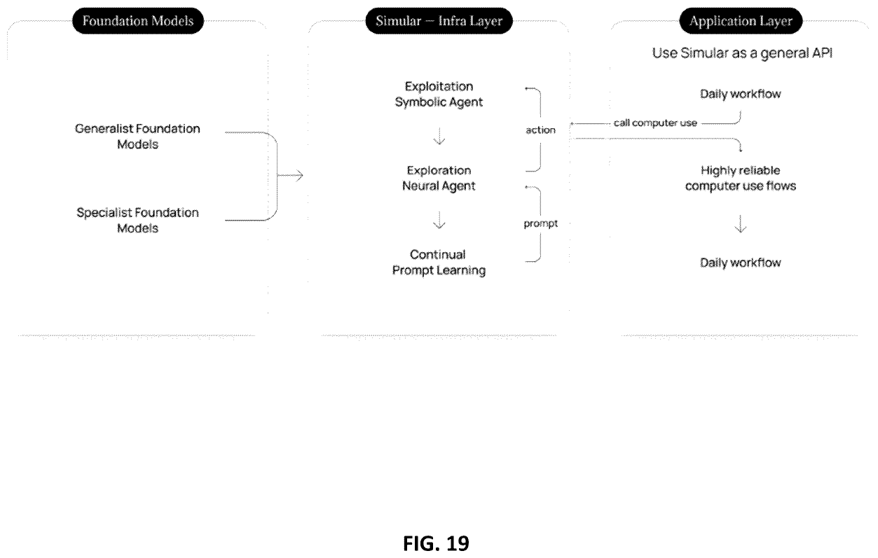

FIG. 19 is a diagram illustrating an architecture 1900 of the system in some embodiments. The system provides a core infrastructure for autonomous computers, where the system performs a wide range of digital tasks like humans, serving as an intelligent layer between people and machines. The system may be considered a neuro-symbolic, dual-agent continual reinforcement learning architecture that powers the infrastructure, unlocking general-purpose, production-grade computer use at scale. In some embodiments, the system includes an exploitation agent, an exploration agent, and an evolutionary reinforcement learning platform.

The exploitation agent operates on structured UI representations such as accessibility trees and DOMs to execute certifiably correct actions on interface elements. It leverages a symbolic abstraction layer that enables high-precision, deterministic workflow execution, eliminating the instability and opaqueness typically associated with neural network-based models. These workflows are expressed in a javascript-syntax language called SimuLang, our domain-specific symbolic language designed to model computer use workflows.

The exploration agent, powered by vision-language models (VLMs), is responsible for navigating unfamiliar or changing environments. When UI shifts or application updates, code execution may fail. In such cases, the exploration agent is activated. Successful trajectories discovered are transferred to exploitation agents using a form of Simulang code.

The evolutionary reinforcement learning platform deploys dedicated, compute-intensive exploration agents in parallel with a broader search budget and longer time horizon. The trajectories collected during exploration are used to evolve the meta-prompter, a learned module optimized through evolutionary methods to generate system prompts that improve the success rate of similar tasks. At runtime, the meta-prompter selects prompts dynamically, conditioned on the input task and the current state of the environment.

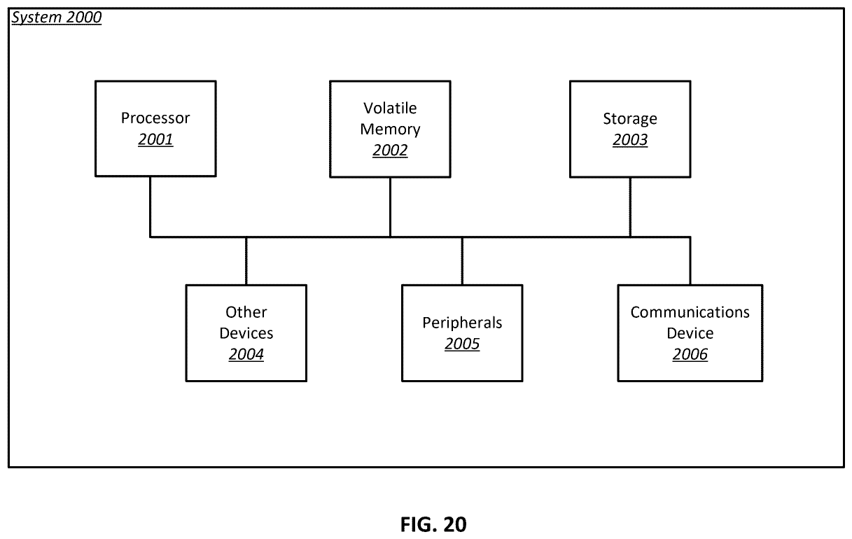

FIG. 20 is a diagram illustrating an exemplary computer that may perform processing in some embodiments. Exemplary computer 2000 may perform operations consistent with some embodiments. The architecture of computer 2000 is exemplary. Computers can be implemented in a variety of other ways. A wide variety of computers can be used in accordance with the embodiments herein.

Processor 2001 may perform computing functions such as running computer programs. The volatile memory 2002 may provide temporary storage of data for the processor 2001. RAM is one kind of volatile memory. Volatile memory typically requires power to maintain its stored information. Storage 2003 provides computer storage for data, instructions, and/or arbitrary information. Non-volatile memory, which can preserve data even when not powered and including disks and flash memory, is an example of storage. Storage 2003 may be organized as a file system, database, or in other ways. Data, instructions, and information may be loaded from storage 2003 into volatile memory 2002 for processing by the processor 2001.

The computer 2000 may include peripherals 2005. Peripherals 2005 may include input peripherals such as a keyboard, mouse, trackball, video camera, microphone, and other input devices. Peripherals 2005 may also include output devices such as a display. Communications device 2006 may connect the computer 2000 to an external medium. For example, communications device 2006 may take the form of a network adapter that provides communications to a network. A computer 2000 may also include a variety of other devices 2004. The various components of the computer 2000 may be connected by a connection medium such as a bus, crossbar, or network.

It will be appreciated that the present disclosure may include any one and up to all of the following examples.

Example 1. A computer-implemented method comprising the operations of: receiving, via a user interface of a client device, an input related to the execution of a computer-related task, the input comprising a text or an audio signal converted to text; determining, one or more services, databases or APIs to retrieve data or information related to the received input, and receiving asynchronously the data or information; determining one or more actions to be performed responsive to received input; providing as input as a prompt to one or more machine learning models comprising a large language model (LLM), the received input and/or the determined or more actions; receiving one or more augmented actions from the LLM; and performing the one or more augmented actions by the client device.

Example 2. The method of Example 1, further comprising the operations of: extracting from the received input relevant text to form a query.

Example 3. The method of any one of Examples 1-2, where in the relevant text is extracted by: generating a prompt as input to a large language model, wherein the prompt requests that the input be analyzed and a question be formulated to search the Internet for information helpful to the execution of a task associated with the input; and providing the text of the received input to the LLM; and providing the generated prompt to the LLM and receiving an output from the LLM based on the generated prompt.

Example 4. The method of any one of Examples 1-3, further comprising: performing a search of online Internet-accessible information and/or a local knowledge base of the client device using at least in part a portion of the question generated by the LLM.

Example 5. The method of any one of Examples 1-4, further comprising the operations of: generating another prompt as input to the large language model, wherein the prompt requests whether to incorporate the web search results with the knowledge base search results; providing the web search results and the knowledge base search results to the LLM; providing the another prompt to the LLM; and receiving a response from the LLM that includes actions to be performed.

Example 6. The method of any one of Examples 1-5, further comprising the operations of: augmenting a task to be performed with actions determined by the LLM.

Example 7. The method of any one of Examples 1-6, wherein the actions comprise an action flow.

Example 8. The method of any one of Examples 1-7, wherein the one or more actions comprises selection of one or more applications or computer services on the computing device.

Example 9. A system comprising, one or more processors configured to perform the operations of: receiving, via a user interface of a client device, an input related to the execution of a computer-related task, the input comprising a text or an audio signal converted to text; determining, one or more services, databases or APIs to retrieve data or information related to the received input, and receiving asynchronously the data or information; determining one or more actions to be performed responsive to received input; providing as input as a prompt to one or more machine learning models comprising a large language model (LLM), the received input and/or the determined or more actions; receiving one or more augmented actions from the LLM; and performing the one or more augmented actions by the client device.

Example 10. The system of Example 9, further comprising the operations of: extracting from the received input relevant text to form a query.

Example 11. The system of any one of Examples 9-10, where in the relevant text is extracted by: generating a prompt as input to a large language model, wherein the prompt requests that the input be analyzed and a question be formulated to search the Internet for information helpful to the execution of a task associated with the input; and providing the text of the received input to the LLM; providing the generated prompt to the LLM and receiving an output from the LLM based on the generated prompt.

Example 12. The system of any one of Examples 9-11, further comprising: performing a search of online Internet-accessible information and/or a local knowledge base of the client device using at least in part a portion of the question generated by the LLM.

Example 13. The system of any one of Examples 9-12, further comprising the operations of: generating another prompt as input to the large language model, wherein the prompt requests whether to incorporate the web search results with the knowledge base search results; providing the web search results and the knowledge base search results to the LLM; providing the another prompt to the LLM; receiving a response from the LLM that includes actions to be performed.

Example 14. The system of any one of Examples 9-13, further comprising the operations of: augmenting a task to be performed with actions determined by the LLM.

Example 15. The system of any one of Examples 9-14, wherein the actions comprise an action flow.

Example 16. The system of any one of Examples 9-15, wherein the one or more actions comprises selection of one or more applications or computer services on the computing device.

Example 17. A non-transitory computer-readable medium containing instructions for generating a note with session content from a communication session, comprising instructions for: receiving, via a user interface of a client device, an input related to the execution of a task to be performed by the client device, the input comprising a text or an audio signal converted to text; determining, one or more services, databases or APIs to retrieve data or information related to the received input, and receiving asynchronously the data or information; determining one or more actions to be performed responsive to received input; providing as input as a prompt to one or more machine learning models comprising a large language model, the received input and/or the determined or more actions; performing the one or more determined actions by the system, wherein the one or more actions comprises selection of one or more applications or computer services on the computing device; and performing the determined one or more actions by the client device.

Example 18. The non-transitory computer-readable medium of Example 17, further comprising: instructions for extracting from the received input relevant text to form a query.

Example 19. The non-transitory computer-readable medium of any one of Examples 17-18, where in the relevant text is extracted by: generating a prompt as input to a large language model, wherein the prompt requests that the input be analyzed, and a question be formulated to search the Internet for information helpful to the execution of a task associated with the input; and providing the text of the received input to the LLM; and providing the generated prompt to the LLM and receiving an output from the LLM based on the generated prompt.

Example 20. The non-transitory computer-readable medium any one of Examples 17-19, further comprising: instructions for performing a search of online Internet-accessible information and/or a local knowledge base of the client device using at least in part a portion of the question generated by the LLM.

Example 21. The non-transitory computer-readable medium of any one of Examples 17-20, further comprising the operations of: generating another prompt as input to the large language model, wherein the prompt requests whether to incorporate the web search results with the knowledge base search results; providing the web search results and the knowledge base search results to the LLM; providing the another prompt to the LLM; and receiving a response from the LLM that includes actions to be performed.

Example 22. The non-transitory computer-readable medium any one of Examples 17-21, further comprising: instructions for augmenting a task to be performed with actions determined by the LLM.

Example 23. The non-transitory computer-readable medium any one of Examples 17-22, wherein the actions comprise an action flow.

Example 24. The non-transitory computer-readable medium any one of Examples 17-23, wherein the one or more actions comprises selection of one or more applications or computer services on the computing device.

Example 25. A computer-implemented method comprising the operations of:
receiving, via a user interface of a client device, an input related to a user query;
based on the received user query, generating, by an artificial intelligence agent, an execution plan, wherein the execution plan comprises a code plan comprises a task listing of tasks comprising computer commands or instructions to be performed by the artificial agent; and
performing the code plan by the artificial intelligence agent, where the artificial intelligence agent causes a control or operation of a separate application, software, operating system or web browser.

Example 26. The computer-implemented method of Example 25, wherein performing the code plan comprises:
executing a task of the code plan, wherein the performance of the task by the artificial intelligence agent causes an operation to be performed on the separate application, software, operation system or web browser.

Example 27. The computer-implemented method of Example 26, further comprising:
determining whether the performance of the task was successful or unsuccessful;
if the task was successful, then performing, by the artificial intelligence agent, a next task in the code plan; and
if the task was unsuccessful, then generating by the artificial agent a replacement code plan to perform the task with a different task comprising computer code or instructions that are different than the computer code or instructions of the unsuccessful task.

Example 28. The computer-implemented method of any one of Example 26-27, further comprising:
initiating a sub-artificial intelligence agent to perform a task, where the artificial intelligence agent generates a sub-code plan that includes multiple tasks to perform the task, wherein the multiple tasks comprise a sub-task listing of tasks comprising computer commands or instructions to be performed by the artificial agent; and
performing by the sub-artificial intelligence agent, the generated sub-code plan, by executing the sub-task listing of tasks.

Example 29. The computer-implemented method of any one of Example 26-28, further comprising:
obtaining an image of a web page or of a user interface of an application;
determining a pixel coordinate location of one or more user interface controls; and
and causing the task to be performed at the determined pixel coordinate location of the web page or the user interface of the application.

Example 30. The computer-implemented method of any one of Examples 26-29, further comprising:
obtaining an image of a web page or of a user interface of an application;
determining a pixel coordinate location of one or more words; and
and causing the task to be performed at the determined pixel coordinate location of the one or more words.

Example 31. The computer-implemented method of any one of Examples 26-30, further comprising:
determining a dictionary of <“cell”:“value”> mapping of a cell-based worksheet; and
and causing the task to be performed at a particular cell location of the cell-based worksheet.

Example 32. A system comprising, one or more processors configured to perform the operations of:
receiving, via a user interface of a client device, an input related to a user query;
based on the received user query, generating, by an artificial intelligence agent, an execution plan, wherein the execution plan comprises a code plan comprises a task listing of tasks comprising computer commands or instructions to be performed by the artificial agent; and performing the code plan by the artificial intelligence agent, where the artificial intelligence agent causes a control or operation of a separate application, software, operating system or web browser.

Example 33. The system of Example 32, wherein performing the code plan comprises:
executing a task of the code plan, wherein the performance of the task by the artificial intelligence agent causes an operation to be performed on the separate application, software, operation system or web browser.

Example 34. The system of Example 32, further comprising:
determining whether the performance of the task was successful or unsuccessful;
if the task was successful, then performing, by the artificial intelligence agent, a next task in the code plan; and
if the task was unsuccessful, then generating by the artificial agent a replacement code plan to perform the task with a different task comprising computer code or instructions that are different than the computer code or instructions of the unsuccessful task.

Example 35. The system of any one of Example 32-34, further comprising:
initiating a sub-artificial intelligence agent to perform a task, where the artificial intelligence agent generates a sub-code plan that includes multiple tasks to perform the task, wherein the multiple tasks comprise a sub-task listing of tasks comprising computer commands or instructions to be performed by the artificial agent; and performing by the sub-artificial intelligence agent, the generated sub-code plan, by executing the sub-task listing of tasks.

Example 36. The system of any one of Example 32-35, further comprising:
obtaining an image of a web page or of a user interface of an application;
determining a pixel coordinate location of one or more user interface controls; and
and causing the task to be performed at the determined pixel coordinate location of the web page or the user interface of the application.

Example 37. The system of any one of Examples 32-36, further comprising:
obtaining an image of a web page or of a user interface of an application;
determining a pixel coordinate location of one or more words; and
and causing the task to be performed at the determined pixel coordinate location of the one or more words.

Example 38. The system of any one of Examples 32-37, further comprising:
determining a dictionary of <“cell”:“value”> mapping of a cell-based worksheet; and
and causing the task to be performed at a particular cell location of the cell-based worksheet.

Some portions of the preceding detailed descriptions have been presented in terms of algorithms, equations and/or symbolic representations of operations on data bits within a computer memory. These algorithmic and/or equation descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method comprising the operations as described herein:
receiving, via a user interface of a client device, an input related to the execution of a computer-related task, the input comprising a text or an audio signal converted to text;
determining, one or more services, databases or APIs to retrieve data or information related to the received input, and receiving asynchronously the data or information;
determining one or more actions to be performed responsive to received input;
providing as input as a prompt to one or more machine learning models comprising a large language model (LLM), the received input and/or the determined or more actions;
receiving one or more augmented actions from the LLM; and performing the one or more augmented actions by the client device.

2. The method of claim 1, further comprising the operations of:
extracting from the received input relevant text to form a query.

3. The method of claim 2, where in the relevant text is extracted by:
generating a prompt as input to a large language model, wherein the prompt requests that the input be analyzed and a question be formulated to search the Internet for information helpful to the execution of a task associated with the input; and
providing the text of the received input to the LLM; and
providing the generated prompt to the LLM and receiving an output from the LLM based on the generated prompt.

4. The method of claim 1, further comprising:
performing a search of online Internet-accessible information and/or a local knowledge base of the client device using at least in part a portion of the question generated by the LLM.

5. The method of claim 4, further comprising the operations of:
generating another prompt as input to the large language model, wherein the prompt requests whether to incorporate the web search results with the knowledge base search results;
providing the web search results and the knowledge base search results to the LLM;
providing the another prompt to the LLM; and
receiving a response from the LLM that includes actions to be performed.

6. The method of claim 5, further comprising the operations of:
augmenting a task to be performed with actions determined by the LLM.

7. The method of claim 1, wherein the actions comprise an action flow.

8. The method of claim 1, wherein the one or more actions comprises selection of one or more applications or computer services on the computing device.

9. A system comprising, one or more processors configured to perform the operations of:
receiving, via a user interface of a client device, an input related to the execution of a task to be performed by the client device, the input comprising a text or an audio signal converted to text;
determining, one or more services, databases or APIs to retrieve data or information related to the received input, and receiving asynchronously the data or information;
determining one or more actions to be performed responsive to received input;
providing as input as a prompt to one or more machine learning models comprising a large language model, the received input and/or the determined or more actions
performing the one or more determined actions by the system, wherein the one or more actions comprises selection of one or more applications or computer services on the computing device; and
performing the one or more actions by the client device.

10. The system of claim 9, further comprising the operations of:
extracting from the received input relevant text to form a query.

11. The system of claim 10, where in the relevant text is extracted by:
generating a prompt as input to a large language model, wherein the prompt requests that the input be analyzed and a question be formulated to search the Internet for information helpful to the execution of a task associated with the input; and
providing the text of the received input to the LLM;
providing the generated prompt to the LLM and receiving an output from the LLM based on the generated prompt.

12. The system of claim 9, further comprising:
performing a search of online Internet-accessible information and/or a local knowledge base of the client device using at least in part a portion of the question generated by the LLM.

13. The system of claim 12, further comprising the operations of:
generating another prompt as input to the large language model, wherein the prompt requests whether to incorporate the web search results with the knowledge base search results;
providing the web search results and the knowledge base search results to the LLM;
providing the another prompt to the LLM;
receiving a response from the LLM that includes actions to be performed.

14. The system of claim 13, further comprising the operations of:
augmenting a task to be performed with actions determined by the LLM.

15. The system of claim 1, wherein the actions comprise an action flow.

16. The method of claim 1, wherein the one or more actions comprises selection of one or more applications or computer services on the computing device.

17. A non-transitory computer-readable medium containing instructions for generating a note with session content from a communication session, comprising instructions for:
receiving, via a user interface of a client device, an input related to the execution of a task to be performed by the client device, the input comprising a text or an audio signal converted to text;
determining, one or more services, databases or APIs to retrieve data or information related to the received input, and receiving asynchronously the data or information;
determining one or more actions to be performed responsive to received input;
providing as input as a prompt to one or more machine learning models comprising a large language model, the received input and/or the determined or more actions performing the one or more determined actions by the system, wherein the one or more actions comprises selection of one or more applications or computer services on the computing device; and
performing the determined one or more actions by the client device.

18. The non-transitory computer-readable medium of claim 17, further comprising:
instructions for extracting from the received input relevant text to form a query.

19. The non-transitory computer-readable medium of claim 18, where in the relevant text is extracted by:
generating a prompt as input to a large language model, wherein the prompt requests that the input be analyzed, and a question be formulated to search the Internet for information helpful to the execution of a task associated with the input; and
providing the text of the received input to the LLM;
providing the generated prompt to the LLM and receiving an output from the LLM based on the generated prompt.

20. The non-transitory computer-readable medium of claim 17, further comprising:
instructions for performing a search of online Internet-accessible information and/or a local knowledge base of the client device using at least in part a portion of the question generated by the LLM.

21. The non-transitory computer-readable medium of claim 20, further comprising the operations of:
generating another prompt as input to the large language model, wherein the prompt requests whether to incorporate the web search results with the knowledge base search results;
providing the web search results and the knowledge base search results to the LLM;
providing the another prompt to the LLM;
receiving a response from the LLM that includes actions to be performed.

22. The non-transitory computer-readable medium of claim 21, further comprising:
instructions for augmenting a task to be performed with actions determined by the LLM.

23. The non-transitory computer-readable medium of claim 17, wherein the actions comprise an action flow.

24. The non-transitory computer-readable medium of claim 17, wherein the one or more actions comprises selection of one or more applications or computer services on the computing device.
